(19) United States
(12) Patent Application Publication
(10) Pub. No.: US 2011/0014012 A1
(43) Pub. Date: Jan. 20, 2011

(54) Glue application device

(76) Inventor: Holger Müller-Lorenschat, Rahden (DE)

Correspondence Address: ALIX YALE & RISTAS LLP, 750 MAIN STREET, SUITE 1400, HARTFORD, CT, 06103, US

(21) Appl. No.: 12/802,827

(22) Filed: Jun. 15, 2010

(30) Foreign Application Priority Data
Jul. 15, 2009 (DE) DE 102009033101.8

(51) Int. Cl. B42C 9/00

(52) U.S. Cl. 412/37

(57) ABSTRACT

A device for applying glue (5) onto the spine (2a) and/or lateral regions near the spine of book blocks (2) that are moved past the device in a transport mechanism. The device features a glue basin (6, 8), and at least one rotationally driven application roller (3) that dips into the glue basin (6, 8) and rolls on the book block (2) with its circumference. At least the surface of the glue basin (6, 8) that is in contact with the glue (5) consists of a flexible and/or elastic material (6, 9). The glue basin (8) preferably features an elastic insert (9) that can be removed from the glue basin (8) for cleaning purposes.

### BACKGROUND

The present invention pertains to a device for applying glue onto the spine and/or lateral regions near the spine of book blocks that are moved past the device in a transport mechanism, over a glue basin and glued with at least one rotationally driven application roller that dips into the glue basin and rolls on the book block with its circumference.

Glue application devices of the aforementioned type are referred to as roller-type gluing stations and described and illustrated in [Liebau, Heinze; Industrielle Buchbinderei; Beruf & Schule Publishing; 2001; Page 284 ff.].

Components of the gluing stations and accessories that come in contact with glue, particularly for processing PUR and dispersion, are coated in order to simplify cleaning and to ensure the required resistance to chemicals. These coatings are always subjected to wear. When using highly adhesive or flexible glues suitable for the subsequent rounding of the book blocks, it is quite tedious to clean, in particular, the glue basins and the drip pans despite their non-stick coating because there frequently is no starting point for peeling off the glue. The users frequently manage by inserting a cord, a cardboard strip or the like into the still liquid glue. However, even this measure is not helpful when using permanently adhesive glues.

The coatings may last for less than a year depending on certain factors such as, e.g., frequency of use and maintenance. The replacement of the coating is very costly and time-consuming, particularly with respect to the glue basin. The replacement is frequently delayed until it is nearly impossible to clean and operate the gluing station. This increases the cleaning expenditures and the risk of producing flawed products until the replacement is carried out. In addition, this also increases the probability of no longer being able to recondition components such that they need to be replaced with new components.

### SUMMARY

The invention is based on the objective of simplifying the cleaning of and reducing the maintenance expenditures in a roller-type glue application device.

According to the present disclosure, this objective is attained in that at least the surface of the glue basin that is in contact with the glue consists of a flexible and/or elastic material. The flexibility or elasticity of the surface makes it possible to easily remove, in particular, hardened glue such as dispersion, reacted PUR-adhesive and solidified hot-melt adhesive. The starting point for peeling off adhering glue can be easily created and the basin is quasi peeled off the glue rather than the glue off the basin. Cleaning of the surface with scrapers or other sharp-edged tools is not required such that the surface remains free of damages for a very long period of time. The elastic surface is furthermore insensitive to thermal and external mechanical stresses.

It is even easier to remove the glue from the glue basin if the surface has non-stick properties. Heat-resistant material is advantageous for processing hot-melt adhesives because they are melted in a high processing temperature in a heated glue basin depending on the type of adhesive. A material with adequate thermal conductivity is advantageous for achieving a suitable heat transfer. The material preferably consists of a silicone elastomer.

In one preferred embodiment, the glue basin is realized in the form of a flexible pan of the corresponding material. The pan can be bent at different locations in order to remove the hardened glue from the pan. The flexible pan is preferably accommodated in a support device. Consequently, the pan does not have to be realized in a self-supporting fashion and may have a thin wall thickness such that a particularly high flexibility is achieved.

In another embodiment, the glue basin features an elastic insert of the corresponding material. The actual glue basin may conventionally consist of a metal and is provided with the corresponding material on the inner side of the basin. The glue basin does not require an expensive coating because it is protected from the glue by the elastic insert. It is also possible to retrofit a glue basin with an elastic insert.

The cleaning of the glue basin is significantly simplified due to the fact that the elastic insert can be removed from the glue basin together with the glue. Particularly glues that are still liquid can be easily removed from the glue basin in this fashion.

If the elastic insert is realized in the form of a disposable part, the residual glue can be simply disposed of together with the insert and it is not necessary to clean the insert.

The application roller and/or a downstream spinner preferably features an attachable sleeve of the flexible and/or elastic material such that cleaning is also significantly simplified in this case.

It is also advantageous to provide a drip pan with a surface of flexible and/or elastic material, in particular, when liquid and/or permanently adhesive glue is drained from the glue basin.

### BRIEF DESCRIPTION OF THE DRAWING

The detailed description of preferred embodiments refers to the attached drawing, in which:

FIG. 1 shows a glue application device with a glue basin in the form of a flexible pan;

FIG. 2 shows a glue basin with an elastic insert; and

FIG. 3 shows a drip pan with an elastic insert.

### DETAILED DESCRIPTION

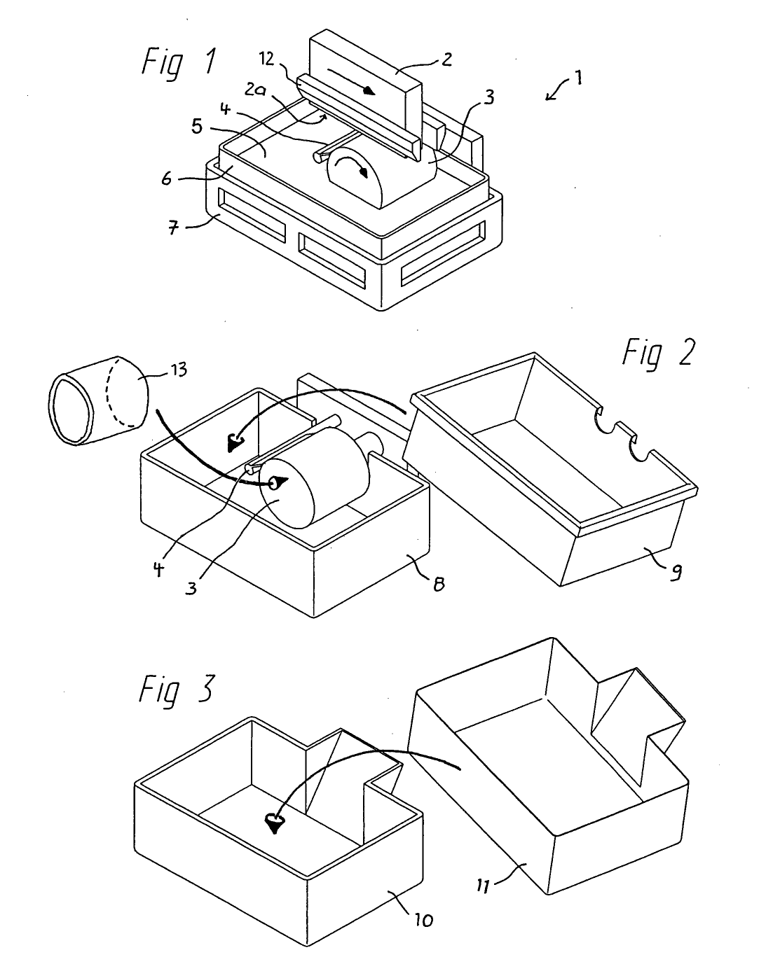

FIG. 1 shows a glue application device 1 for a perfect binding system, in which book blocks 2 gathered from folded sections and/or single sheets are bound in the spine 2a. Book blocks 2 are transported in the direction of the arrow in clamps 12 of a conventional (not-shown) transport mechanism. Glue is applied onto the downwardly protruding spines 2a while they pass the glue application device 1. The term “spine region” should be understood as encompassing the spine and the lateral surfaces or regions adjacent to the spine.

The glue application device 1 includes an application roller 3 that is rotationally driven synchronous with the book block 2. It dips into a pan 6 that is filled with glue 5, picks up glue 5 with its outer circumferential surface and transfers the glue 5 onto the book block spine 2a in the form of a rolling movement. The thickness and length of the glue layer to be transferred onto the book block spine 2a is defined by a scraper 4 that can be adjusted with respect to its distance from the application roller 3. Excess glue 5 is scraped off the application roller 3 by the scraper 4 and flows back into the pan 6.

According to the present disclosure, the pan 6 is realized flexibly, i.e., it can be bent. The flexibility and the elasticity of the surface make it possible to easily remove, in particular, hardened residual glue such as dispersion, reacted PUR-adhesive or solidified hot-melt adhesive. A starting point for peeling off the glue 5 adhering to the surface can be easily created by bending the pan. In this case, the pan 6 is quasi peeled off the glue 5 rather than the glue off the pan. The removal of the glue 5, particularly still liquid glue, is significantly simplified by a surface with non-stick properties. In order to ensure the stability of the flexible pan 6, the pan 6 is accommodated in a support device 7. The term “flexible” should be understood as encompassing “elastic”.

A second embodiment is illustrated in FIG. 2. In this case, a conventional heated glue basin 8 of metal is provided with a thin-walled elastic insert 9 of a silicone elastomer that is resistant to heat and chemicals. The insert 9 is so flexible that it can be placed into the glue basin 8 and removed again around the application roller 3 and the scraper 4. Glue residues therefore can be removed from the glue basin 8 together with the insert 9. The glue residues can be removed from the insert 9 outside the glue application device 1 or disposed of with the flexible insert 9 if the inserts 9 are realize in the form of disposable parts. An attachable sleeve 13 of flexible material can be provided around the application roller 3, such that cleaning is also significantly simplified in this case.

FIG. 3 shows a drip pan 10 for collecting glue 5 that is overaged or no longer needed and drained from the glue basin 8. The drip pan 10 is lined with a flexible insert 11 such that, in particular, permanently adhesive glues 5 can be very easily removed from the drip pan 10.

1. A device for applying glue onto the spine region of book blocks that are moved past the device in a transport mechanism, said device including a glue basin having a contact surface for containing the glue and at least one rotationally driven application roller that dips into the glue basin and rolls on the spine region with its circumference, wherein the improvement comprises that at least the contact surface of the glue basin consists of a flexible material.

2. The device according to claim 1, wherein the contact surface has non-stick properties.

3. The device according to claim 1, wherein the flexible material is heat-resistant.

4. The device according to claim 1, wherein the flexible material has an adequate thermal conductivity.

5. The device according to claim 1, wherein the flexible material is a silicone elastomer.

6. The device according to claim 1, wherein the glue basin is in the form of a flexible pan.

7. The device according to claim 6, wherein the flexible pan is accommodated in a support device.

8. The device according to claim 1, wherein the glue basin includes an elastic insert that defines the contact surface.

9. The device according to claim 8, wherein the elastic insert is removable from, cleanable, and reinsertable in the glue basin.

10. The device according to claim 8, wherein the elastic insert is realized in the form of a disposable part.

11. The device according to claim 1, wherein a sleeve of the flexible material is attachable around the application roller.

12. The device according to claim 1, including a drip pan for glue drained from the glue basin, which drip pan has a glue-receiving surface of flexible material.

13. The device according to claim 6, wherein the flexible material is a silicone elastomer.

14. The device according to claim 13, wherein the flexible pan is accommodated in a support device.

15. The device according to claim 8, wherein the flexible material is a silicone elastomer.

16. The device according to claim 6, wherein the contact surface has non-stick properties.

17. The device according to claim 16, wherein the flexible pan is accommodated in a support device.

18. The device according to claim 8, wherein the contact surface has non-stick properties.

19. The device according to claim 18, wherein the elastic insert is removable from, cleanable, and reinsertable in the glue basin.
